(19) United States
(12) Patent Application Publication
(10) Pub. No.: US 2006/0098877 A1
(43) Pub. Date: May 11, 2006

(54) Detecting shapes in image data

(76) Inventors: Nick Barnes, Girdang (AU); Gareth Loy, Stockholm (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/169,288

(22) Filed: Jun. 28, 2005

(30) Foreign Application Priority Data
Nov. 9, 2004 (AU) 2004906429

(51) Int. Cl. G06K 9/46; G06K 9/48

(52) U.S. Cl. 382/203; 382/199

(57) ABSTRACT

This invention concerns a method for detecting shapes in image data. In particular but not exclusively the method concerns the detection of regular polygons in scanline data. The method includes identifying intensity gradient vectors in the image. Then each point at an identified intensity gradient is considered to be on the side of the shape. Voting is then performed for possible centres of the shape that are in the direction of the gradient intensity vector. The centre of that shape is determined from the votes. In further aspects the invention concerns software and computers programmed to perform the method.

### FIELD OF THE INVENTION

This invention concerns a method for detecting shapes in image data. In particular but not exclusively the method concerns the detection of regular polygons in scanline data. In further aspects the invention concerns software and computers programmed to perform the method.

### BACKGROUND ART

There has been considerable interest in the automatic detection of points of interest in images. The paper entitled Fast Radial Symmetry for Detecting Points of Interest by Gareth Loy and Alexander Zelinsky in IEEE Transactions on Pattern Analysis and Machine Intelligence, Vol 25, No 8, of August 2003 provides a survey of relevant background.

### DISCLOSURE OF THE INVENTION

In a first aspect, the invention provides a method for detecting in image data regular polygon shapes having three or more straight sides of equal length in image data, the method comprising:

reading the image data;

identifying intensity gradient vectors in the image, each intensity gradient vector being substantially perpendicular to a side of the shape;

considering each point at an identified intensity gradient to be on the side of the shape;

voting for possible centers of the shape using the gradient intensity vector; and

determining the center of that shape from the votes.

Using this method it is possible to find, for instance, all possible regular polygons of a particular radius and number of sides by searching through a single vote space that is typically the same size as the image.

The method may further comprise multiplying the angular value of the vector of the intensity gradient of each point on the side of the shape by the number of sides of the shape, and weighting one or more votes by the angular multiplied vector.

Examples of shapes the method is able to detect includes regular triangles, squares, pentagons, hexagons, octagons and circles.

Thresholding may be applied to the gradients to remove from the detection method unwanted edges in the image that do not correspond to sides of the shape.

Voting may comprise constructing one or more vote images that are used in determining the center of the shape. These vote images are typically the same size as the image under investigation.

A first vote image may be constructed by awarding, for each point on the side of the shape, positive votes to points deemed to be candidate centers of the shape, and awarding negative votes to points deemed not to be candidate centers. The candidacy for a point being a center or not may be determined using mathematical methods based on the radius of the shape. A radius of the shape may be taken to be the shortest distance from any side to the center.

The step of weighting one or more votes by the angular multiplied vector may construct a second vote image. Alternatively, or in addition, the second vote image may be constructed by awarding for each point on the side of the shape, positive votes to points deemed to be candidate centers of the shape and adding the angular multiplied vector, and awarding negative votes to points deemed not to be candidate centers and subtracting the angular multiplied vector.

Points deemed to be candidate centers may be a single pixel.

The angular multiplied vector may be resolved into x and y components and the addition and subtraction operations may be performed on x and y components of the vote.

The step of determining the center of the shape may comprise combining the first and second vote image by multiplying corresponding point vote values.

The step of reading image data may be performed using a scanline algorithm.

In further aspects the invention is computer software and programmed computers able to perform the method.

Using this invention, occlusion such as splits or gaps in the sides of the shape under investigation will not lead to the detection of two separate shapes. Further, using the invention if a side of a shape is missing from the image data the shape can still be successfully detected.

At least one embodiment of the invention uses gradient orientation information to help predict the center of the shape. That is, the invention does not use a binary image to predict the center of the shape.

### BRIEF DESCRIPTION OF THE DRAWINGS

An example of the invention will now be described with reference to the accompanying drawings, in which:

FIG. 1 is a sketch of a triangle in an image frame scanned with a series of horizontal scanlines.

FIG. 2 is a sketch of an side point of the triangle and its associated line of voting pixels.

FIGS. 3(a) and (b) are sketches of a triangle showing, respectively, the intensity vector and the new vectors derived by multiplying the angle of the intensity vector by 3.

FIG. 4 is a diagram illustrating gradient voting by the angular multiplied vector.

FIG. 5(a) is an image of a road sign, (b) is the single voting image, (c) is the gradient voting image and (d) is the combined voting image.

### BEST MODES OF THE INVENTION

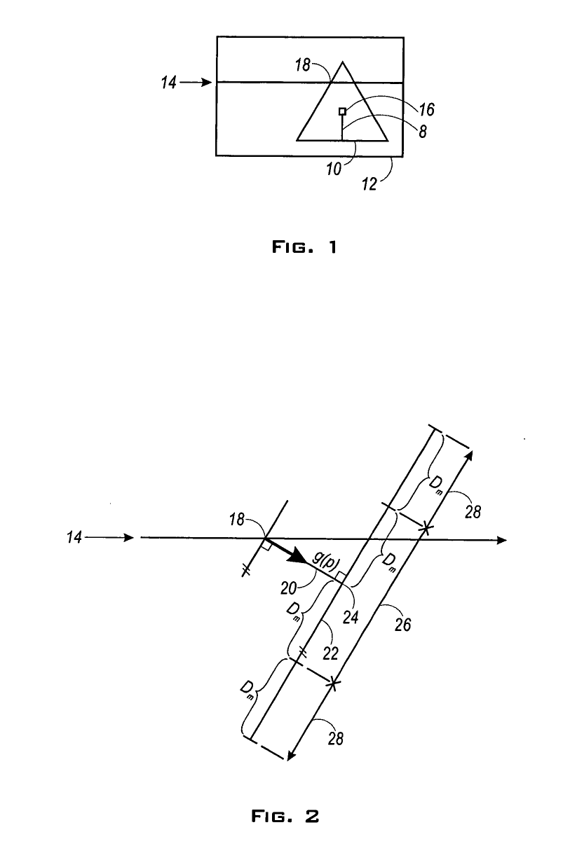

Referring first to FIG. 1, the example is a method for processing scanline data to identify a regular polygon, in this case an equilateral triangle 10, in an image frame 12 which is scanned by horizontal scanlines running from left to right. One of the scanlines is indicated at 14. The center of the triangle is at point 16

The steps in the process include:

(1) Identifying intensity gradients in the image;

(2) Thresholding the gradients;

(3) Applying shape voting; and,

(4) Determining shape centers.

For step (1) any intensity gradient finding image operator can be used that returns spatial gradients of the image intensity in two dimensions. An example of such an operator is the Sobel 3×3 gradient mask. This operator returns an intensity gradient vector g(p) pointing from dark to light that is generally perpendicular to a side.

For step (2) the gradients are thresholded at a level that is suitable to cut out unwanted noise in the image, such as edges in the image that do not correspond to sides of the shape. As a result of thresholding, any point where the gradient magnitude is less than the chosen threshold is not processed further. Thresholds are generally chosen based on image properties, such as background artefacts.

For step (3) the voting will be explained:

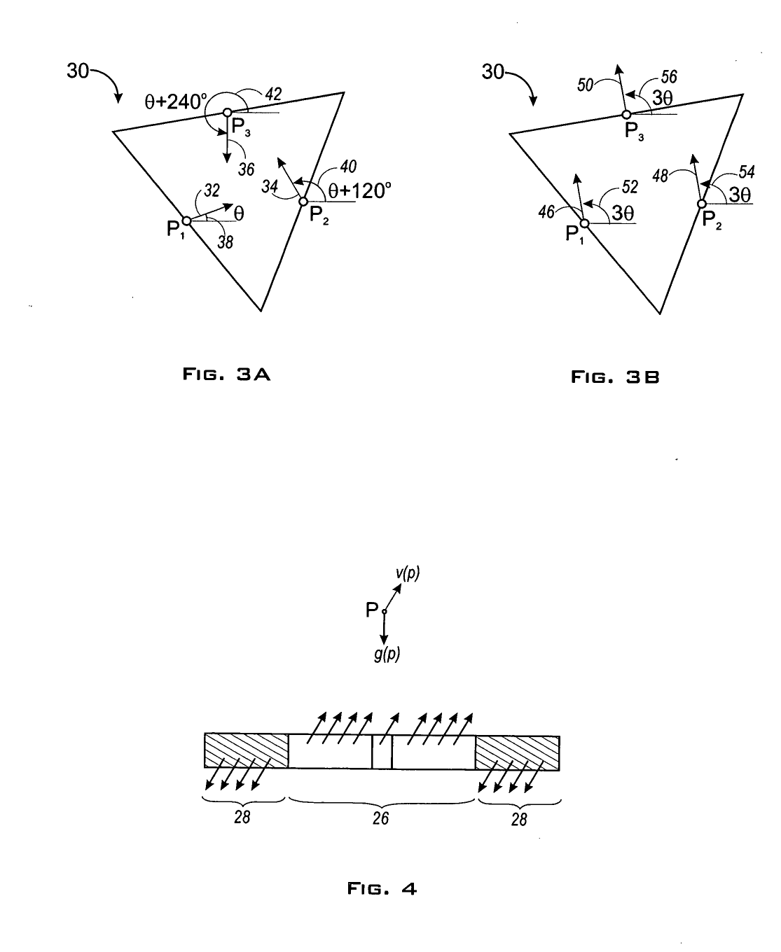

Each point that is identified at a sufficiently high intensity gradient is considered to be a point on the side of the triangle. The first potential side point encountered by scanline 14 is at 18. The potential side point may be a single pixel. FIG. 2 is an enlargement showing vector g(p) at point 18.

In this example the size of the triangle being sought is known. It may have been programmed into the software or may have been entered by the user. Accordingly the ‘radius’ of the triangle is also known. The ‘radius’ is taken to be the shortest distance from any side of the triangle to the center. A radius of triangle 10 has the length R of the line 8 shown in FIG. 1.

In FIG. 2 a line 20 having a length the same as the radius is shown extending from the potential side point 18 on scanline 14 in the direction of vector g(p). A further line 22 passing through the end 24 of line 20 and orthogonal to vector g(p) will pass through the center of the triangle 10.

Since the size of the triangle is known, the maximum distance, in both directions along line 22, from 24 to the center 16 is calculated to be Dₘ, where Dₘ is half the side length of the polygon being detected.

There will then be a vote for each of the points along line 22 upon which the center could fall. These candidate center points are a single pixel. These pixels are designated the positively affected pixels 26.

To prevent over-emphasis of long lines, the set of pixels that extends for a further distance Dₘ along line 22 beyond the positively affected pixels are designated negatively effected pixels 28. All these pixels are just too far away from point 24 to be the center.

Each of the (positively as well as negatively) affected pixels receives a vote in order to identify the center of the triangle. In this example two types of votes are cast to form two separate voting images; the first single vote image and the second gradient vote image.

In the single vote image, a single positive vote is cast for every point in the set of positively affected pixels, and a single negative vote is cast for every point in the set of negatively affected pixels. The result will be peaks in the single vote image at centers of triangles and this can be viewed as points of brightness in a greyscale image.

In the gradient vote image, the angular value of the vector g(p) and the horizontal (or any other common line) is multiplied by the number of sides of the triangle, that is by three for a triangle, to generate a new vector. The new angular multiplied vector provides a rotationally invariant measure of how well a set of sides fits to a particular angular spacing.

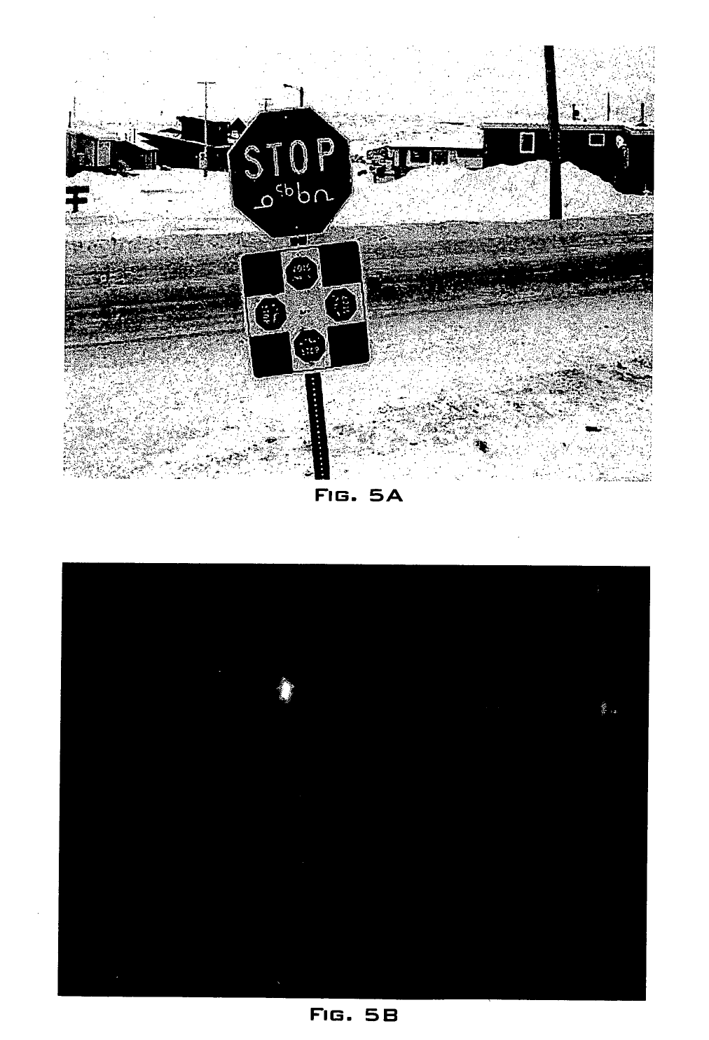

FIG. 3 helps to explain this. FIG. 3a shows a triangle 30 with intensity vectors 32, 34 and 36 marked at the centre of one of the three sides of the triangle 30. When the angles 38, 40 and 42 of each of the vectors 32, 34 and 36 respectively are multiplied by three (being the number of sides of the shape) the resulting angular multiplied vectors 46, 48 and 50 are in parallel. That is, the angular values 52, 54 and 56 respectively are approximately the same. This occurs as a result of the sides of the shape of a triangle naturally having an orientation that is 360° divided by three. As a result the magnitude of the addition of the vectors for 46, 48 and 50 will be the largest possible if the points P1, P2 and P3 each lie on a side of the triangle.

The angle of the new vector is resolved into components in the x and y dimensions, that is x=cos(N*θ), y=sin(N*θ). Then each pixel in the set of positively affected pixels are voted the x component to its x dimension and the y component to its y dimension. Each pixel in the negatively affected pixels is voted a reduction of its x dimension by the x component and a reduction of its y dimension by the y component.

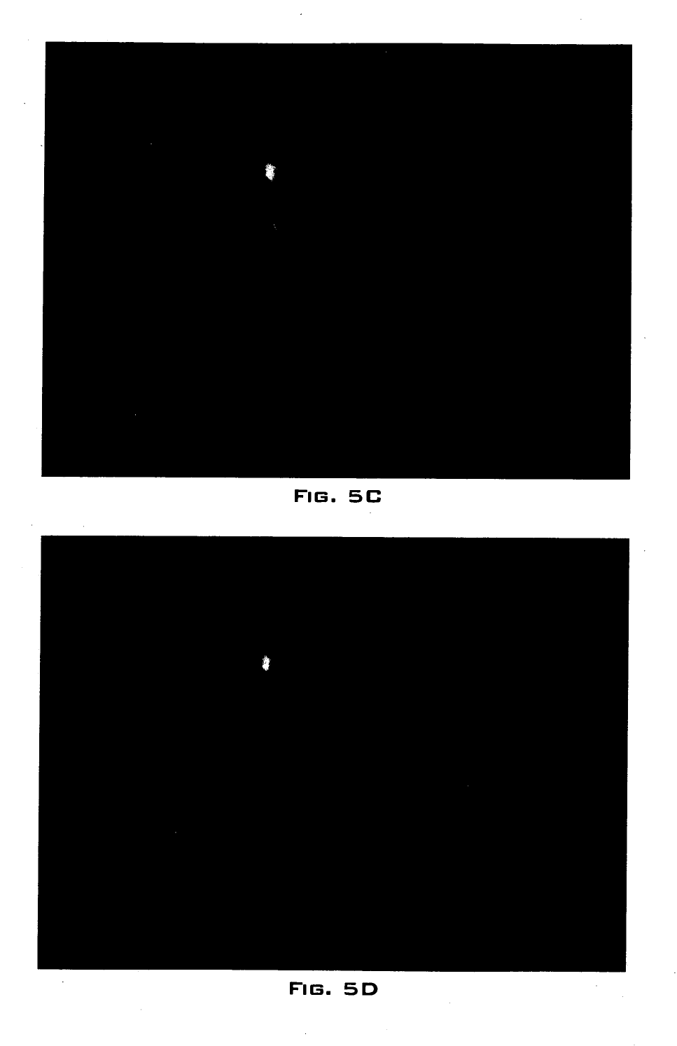

This is further explained with reference to FIG. 4. The vector g(p) points down, but multiplying its angular orientation by 3 gives a new angular multiplied vector v(p), which points to approximately 1 o'clock. The new angular multiplied vector v(p) is vector added to the positively affected pixels 26 and vector subtracted from the negatively affected pixels.

As a result two images are formed which can be viewed to show intensity peaks: the single vote image and the magnitude of the gradient vote image.

In step (4) the two images are combined at each pixel by multiplying the magnitude of the gradient vote image, by the corresponding pixel vote value from the single vote image. At every pixel in the resulting image where the total vote count is sufficiently high, a regular polygon of three sides of radius R has been found.

FIG. 5(a) illustrates the example of an octagonal STOP sign, and in the checkered square below the sign there are four smaller octagons. FIG. 5(b) is the single vote image produced by looking for octagons having the radius of the large octagon. FIG. 5(c) is the gradient vote image for octagons having the radius of the large octagon. And FIG. 5(d) is the combined vote image clearly showing the center of the large octagon as a white dot. Note that the small octagons are not detected at this radii, but would be detected at a smaller radii.

The method may be varied in several important ways. For instance, the method may cope with the situation where the radius is unknown by repeating the voting for each possible length of radius.

By using the gradient direction, the method may be used to differentiate between light to dark and dark to light borders around a shape.

Alternatively, votes can be cast both in front and behind each gradient element allowing the method to detect shapes with both dark to light and light to dark edges.

The method can locate other regular polygons, as well as triangles, by taking account of different numbers of sides.

The invention could also be used to locate the center of non-regular polygons or shapes where some of the sides are curved. Furthermore by using a small radius and large side length the method can be used to detect lines, bands and the intersections of these. The method can be used to find many shapes in an image.

The method may be used with data ordered in any way, not just with scan lines. For instance the method could be implemented to work in parallel with sets of data or the entire image simultaneously.

When the invention is applied to machine reading of road signs from a moving vehicle it may only be necessary to recognise the sign once it is sufficiently close and the radius size sought in the image can be set accordingly.

By considering lower vote counts, regular polygons where some of the points on a side of the shape were not detected can also be found. It may also be sufficient for partial detection to search through either the single vote image, or the gradient vote image separately.

The invention may be applied to any situation where it is useful to find regular polygons in images quickly and efficiently. This includes, but is not exclusive to:

Road sign detection in cars;

Finding repeatable features for visual reconstruction;

Finding repeatable features for robotic applications, such as Mapping, navigation, localisation and Simultaneous Localization and Mapping.

The invention could be installed in passenger vehicles to give the driver a warning as appropriate, or to automatically engage in appropriate car control if necessary.

1. A method for detecting in image data regular polygon shapes having three or more straight sides of equal length, the method comprising:
reading the image data;
identifying intensity gradient vectors in the image, each intensity gradient vector being substantially perpendicular to a side of the shape;
considering each point at an identified intensity gradient to be on the side of the shape;
voting for possible centers of the shape using the gradient intensity vector; and
determining the center of that shape from the votes.

2. The method for detecting in image data regular polygon shapes according to claim 1, wherein voting includes the step of multiplying the angular value of the vector of the intensity gradient of each point on the side of the shape by the number of sides of the shape, and weighting one or more votes by the angular multiplied vector.

3. The method for detecting in image data regular polygon shapes according to claim 1, wherein voting comprises constructing one or more vote images that are used in determining the center of the shape.

4. The method for detecting in image data regular polygon shapes according to claim 3, wherein the vote images are typically the same size as the image data.

5. The method for detecting in image data regular polygon shapes according to claim 3, wherein a first vote image is constructed by awarding, for each point on the side of the shape, positive votes to points deemed to be candidate centers of the shape, and awarding negative votes to points deemed not to be candidate centers.

6. The method for detecting in image data regular polygon shapes according to claim 5, wherein the candidacy for a points being a center or not is determined using mathematical methods.

7. The method for detecting in image data regular polygon shapes according to claim 6, wherein the mathematical method is based on a radius of the shape that is taken to be half the shortest distance across the shape, or the shortest distance from any side to the center.

8. The method for detecting in image data regular polygon shapes according to any one of claims 7, wherein weighting one or more votes by the angular multiplied vector comprises constructing a second vote image.

9. The method for detecting in image data regular polygon shapes according to claim 8, the second vote image is constructed by awarding for each point on the side of the shape, positive votes to points deemed to be candidate centers of the shape and adding the angular multiplied vector, and awarding negative votes to points deemed not to be candidate centers and subtracting the angular multiplied vector.

10. The method for detecting in image data regular polygon shapes according to claim 9, wherein the angular multiplied vector is resolved into x and y components and the addition and subtraction operations are performed on x and y components of the vote.

11. The method for detecting in image data regular polygon shapes according to claim 5, wherein determining the center of the shape comprises combining vote images by multiplying corresponding point vote values.

12. The method for detecting in image data regular polygon shapes according to claim 5, wherein points deemed to be candidate centers consists of a single pixel.

13. The method for detecting in image data regular polygon shapes according to claim 1, wherein reading of image data is performed using a scanline algorithm.

14. Computer software able to perform the method of claim 1, when installed on a computer.

15. A programmed computer able to perform the method of claim 1.
